(19) United States
(12) Patent Application Publication
(10) Pub. No.: US 2016/0050920 A1
(43) Pub. Date: Feb. 25, 2016

(54) METHODS TO IMPROVE NODAL ROOTS

(71) Applicant: Valent BioSciences Corporation, Libertyville, IL (US)

(72) Inventors: Eric Ott, Greenfield, IN (US); Dawn Refsell, Lathrop, MO (US)

(21) Appl. No.: 14/829,932

(22) Filed: Aug. 19, 2015

Related U.S. Application Data
(60) Provisional application No. 62/039,641, filed on Aug. 20, 2014.

(51) Int. Cl. A01N 43/12; A01N 37/06

(52) U.S. Cl. CPC A01N 43/12; A01N 37/06

(57) ABSTRACT

The present invention is directed tomethods for improving nodal root development, nodal root growth, yield, and standability of a cereal grain comprising applying an effective amount of at least one gibberellin to the cereal grain during the early vegetative growth stage.

### FIELD OF THE INVENTION

The present invention is generally directed to methods for improving nodal root growth and development, yield, and standability of cereal grains comprising applying an effective amount of at least one gibberellin to the cereal grains during an early vegetative growth stage.

### BACKGROUND OF THE INVENTION

Crop growers continually strive to produce the healthiest and highest yielding crops available. Higher yielding crops most likely mean higher revenue for the grower but it is also the most efficient way to use the land. Healthier plants are also more resistant to pests and stress from weeds and accordingly require fewer herbicide and pesticide treatments that have the potential to harm the environment and the crops.

One way of assisting crop growers is to genetically develop crop plants with desirable qualities that will improve plant health, vigor, and yield. For example, hybrid crop plants have been developed that are resistant to some diseases, herbicides, and pests. Hybrid plants are developed by selectively crossing plants to obtain a desired trait. Often the hybrid plants may have one desirable quality, such as disease resistance, but suffer from an undesirable trait, such as poor root growth. Developing plants that have only desirable qualities can take an overwhelming amount of resources, such as time, money, and researchers. Therefore, not all undesirable crop plant qualities can be eliminated through hybrid seed research and development.

One issue that some crops suffer from is that their root system is not expansive enough or strong enough to tolerate environmental stresses such as drought or strong winds. For example, the crop plant corn is a grass and has a fibrous root system unlike crops like soybeans which have a tap root. Corn develops roots in two stages. The first phase is the development of the seminal/seed root system. The second phase is the nodal root system. A new set (or whorl) of nodal roots begins to elongate from the lower most nodes (the seedling crown) as each new leaf collar emerges.

Unfavorable environmental conditions while the nodal root system is developing can lead to devastating effects on the seedling. For example, if the soil surface is too dry, the nodal roots may fail to form and the corn plant may die or easily fall over during a windstorm. In addition, poor nodal root development may prevent a plant from recovering from drought conditions because their roots are too underdeveloped to find available moisture that is beyond the roots' reach.

Underdeveloped nodal roots can also lead to poor nitrogen use efficiency. Nitrogen is essential to corn as it a part of all proteins within the plant. Corn needs nitrogen in high quantities and growers must supplement corn with nitrogen if the corn is not able to obtain enough nitrogen from the soil. If nitrogen levels are too low, the corn's development will be stunted. The more developed the nodal root system is, the better the plant will be at taking nitrogen from the soil. This higher nitrogen efficiency will lead to higher yields.

Accordingly, there is a need for new methods to assist growers in growing healthy and high yielding crop plants. The method should be easy to administer and provide excellent nodal root growth and development, standability, and yield. The method should provide increased yield even when the crops are exposed to drought conditions.

### SUMMARY OF THE INVENTION

In one aspect, the present invention is directed to methods for improving nodal root growth and development, improving yield, and improving standability of a cereal grain comprising applying an effective amount of at least one gibberellin to the cereal grain during the early vegetative growth stage.

### DETAILED DESCRIPTION OF THE INVENTION

Unexpectedly, Applicants found that when a gibberellin was applied to cereal grains during the early vegetative stage, the cereal grains had increased nodal root growth and development, yield, and standability.

Specifically, Applicants were surprised that when they applied gibberellic acid (“GA3”) to hybrid corn, wheat and rye plants by foliar spray applications during the V2 to V6 growth stages the plants developed more nodal roots than those plants that were not treated. The treated plants also developed longer nodal roots than those plants that were not treated. This was unexpected because one skilled in the art would not have predicted that GA3 application would increase nodal root growth and development.

Gibberellins are naturally-occurring plant hormones involved in most phases of plant growth and development including germination, cell proliferation, cell elongation, bud break, flowering, sex determination, fruit set, seed development and senescence (reviewed in Olszewskiet al., Gibberellin Signaling: Biosynthesis, Catabolism, and Response Pathways, The Plant Cell, S61-S80, Supplement 2002). GA3 is well-known for its promotion of plant growth and has been used in agriculture since the early 1960's. The major commercial uses of gibberellins include thinning and sizing of seedless table grapes, enhancement of fruit size and firmness, stimulation of growth and increased yield of pasture grasses, promotion of fruit set, and advancement of flowering in horticultural crops (Sponsel, A Companion to Plant Physiology, Fifth Edition by Lincoln Taiz and Eduardo Zeiger, available at http://5e.plantphys.net/article.php?ch=0&id=372, 2010).

In one embodiment, the present invention is directed to methods for increasing at least one of nodal root growth, nodal root development, standability (not leaning more than 45 degrees from an erect position), and yield of a cereal grain comprising applying an effective amount of at least one gibberellin to the cereal grain during the early vegetative growth stage.

In a preferred embodiment, the present invention is directed to methods for increasing nodal root growth of a cereal grain comprising applying an effective amount of at least one gibberellin to the cereal grain during the early vegetative growth stage.

In a preferred embodiment, the present invention is directed to methods for increasing nodal root development of a cereal grain comprising applying an effective amount of at least one gibberellin to the cereal grain during the early vegetative growth stage.

In a preferred embodiment, the present invention is directed to methods for increasing standability of a cereal grain comprising applying an effective amount of at least one gibberellin to the cereal grain during the early vegetative growth stage.

In a preferred embodiment, the present invention is directed to methods for increasing yield of a cereal grain comprising applying an effective amount of at least one gibberellin to the cereal grain during the early vegetative growth stage.

The following embodiments describe each of the methods of the invention including increasing nodal root growth, nodal root development, yield and standability of the cereal grains.

In a further embodiment, the cereal grains are exposed to drought stress. The gibberellins may be applied to the cereals before or after they are exposed to drought stress. For example, a grower could apply a gibberellin in anticipation of drought stress. In response to the gibberellin treatment, the cereal grains would develop additional nodal roots. The additional nodal roots would allow the plant to access moisture further away from the cereal grain than if the cereal grain was not treated.

In a preferred embodiment, the cereal grains are corn, rice, wheat, barley, sorghum, millet, oats, triticale, rye, or fonio. In a more preferred embodiment, the cereal grains are corn, rice, rye, wheat, and sorghum. In another preferred embodiment, the cereal grain is corn. Preferably the corn is popcorn, field corn or sweet corn. The cereal grain of the present invention may be genetically modified (GM) or non-GM.

In an embodiment, the gibberellin is GA1, GA2, GA3, GA4, GA5, GA6, GA7, GA8, GA9, GA10, GA11, GA12, GA13, GA14, GA15, GA16, GA17, GA18, GA19, GA20, GA21, GA22, GA23, GA24, GA25, GA26, GA27, GA28, GA29, GA30, GA31, GA32, GA33, GA34, GA35, GA36, GA37, GA38, GA39, GA40, GA41, GA42, GA43, GA44, GA45, GA46, GA47, GA48, GA49, GA50, GA51, GA52, GA53, GA54, GA55, GA56, GA57, GA58, GA59, GA60, GA61, GA62, GA63, GA64, GA65, GA66, GA67, GA68, GA69, GA70, GA71, GA72, GA73, GA74, GA75, GA76, GA77, GA78, GA79, GA80, GA81, GA82, GA83, GA84, GA85, GA86, GA87, GA88, GA89, GA90, GA91, GA92, GA93, GA94, GA95, GA96, GA97, GA98, GA99, GA100, GA101, GA102, GA103, GA104, GA105, GA106, GA107, GA108, GA109, GA110, GA111, GA112, GA113, GA114, GA115, GA116, GA117, GA118, GA119, GA120, GA121, GA122, GA123, GA124, GA125, GA126, or a combination thereof. In a preferred embodiment, the gibberellin is GA1, GA3, GA4, GA7, or a combination thereof. In a more preferred embodiment, the gibberellin is GA3 or a combination of GA4 and GA7. In a most preferred embodiment, the gibberellin is GA3.

In a further embodiment, the cereal grain is corn and the early vegetative growth stage is during the V1 (plants with one leaf with a visible collar) to V6 (plants with six leaves with visible collars) growth stage. In a preferred embodiment, the growth stage is V4 (plants with four leaves with visible collars) to V5 (plants with five leaves with visible collars).

In an embodiment, the effective amount is from about 1 to 30 grams of gibberellin per hectare. In a preferred embodiment, the effective amount is from about 3 to 20 grams of gibberellin per hectare. In a more preferred embodiment, the effective amount is from about 6 to 18 grams of gibberellin per hectare. In a most preferred embodiment, the effective amount is from about 8 to 17 grams of gibberellin per hectare. In a preferred embodiment, GA3 is applied at from about 1 to about 30, preferably from about 3 to about 20, from about 6 to about 18, and from about 8 to about 17 grams per hectare.

In another embodiment, the gibberellin is applied with at least one herbicide, fungicide, insecticide, fertilizer, mineral, or plant growth regulator that is not a gibberellin. In a preferred embodiment, the gibberellin is applied with at least one plant growth regulator other than a gibberellin.

In another embodiment, the herbicides include but are not limited to glyphosate (or a salt thereof), mesotrione, halosulfuron, saflufenacil or dicamba.

In a further embodiment, the fungicides include but are not limited to tetraconazole, metconazole, a strobilurin, or a combined strobilurin-azole product.

In another embodiment, the insecticides include but are not limited to methylparathion, bifenthryn, esfenvalerate, lorsban, carbaryl or lannate.

In yet another embodiment, the foliar fertilizers include but are not limited to CoRoN (available from Helena Chemical), a controlled-release nitrogen, or BioForge (available from Stoller USA), which is largely N,N′-diformyl urea, or other micro nutrient-containing sprays.

In another embodiment, the minerals include but are not limited to zinc, nitrogen, potassium, calcium, or boron.

In an embodiment, the plant growth regulators include but are not limited to abscisic acid, aminoethoxyvinylglycine, 6-benzyladenine, jasmonic acid, napthylacetic acid or salicylic acid. In a preferred embodiment the plant growth regulator is abscisic acid.

The GA3 can be applied by any convenient means. Those skilled in the art are familiar with the modes of application that include foliar applications such as spraying, dusting, and granular applications; and soil (or alternative media) applications including spraying, in-furrow treatments, side-dressing, or drip-irrigation. In a preferred embodiment, the GA3 is applied by spraying.

Aqueous spray solutions utilized in the present invention generally contain from about 0.01% to 0.5% (v/v) of a surface-active agent.

The surface active agent comprises at least one non-ionic surfactant. In general, the non-ionic surfactant may be any known non-ionic surfactant in the art. Suitable non-ionic surfactants are in general oligomers and polymers. Suitable polymers include alkyleneoxide random and block copolymers such as ethylene oxide-propylene oxide block copolymers (EO/PO block copolymers), including both EO-PO-EO and PO-EO-PO block copolymers; ethylene oxide-butylene oxide random and block copolymers, C2-6 alkyl adducts of ethylene oxide-propylene oxide random and block copolymers, C2-6 alkyl adducts of ethylene oxide-butylene oxide random and block copolymers, polyoxyethylene-polyoxypropylenemonoalkylethers, such as methyl ether, ethyl ether, propyl ether, butyl ether or mixtures thereof; vinylacetate/vinylpyrrolidone copolymers; alkylated vinylpyrrolidone copolymers; polyvinylpyrrolidone; and polyalkyleneglycol, including the polypropylene glycols and polyethylene glycols. Other non-ionic agents are the lecithins; and silicone surface active agents (water soluble or dispersible surface active agents having a skeleton which comprises a siloxane chain e.g. Silwet L77.®). A suitable mixture in mineral oil is ATPLUS 411 F.®

Applicants have referred to corn developmental stages throughout the application as “V” stages. The “V” stages are designated numerically as V1, V2, V3, etc. In this identification system of V(n), (n) represents the number of leaves with visible collars. Each leaf stage is defined according to the uppermost leaf whose leaf collar is visible. “VT” refers to tassel emergence growth stage and is not an early vegetative stage of corn.

As used herein, “drought” refers to a time when the grain has an insufficient water supply resulting in stunting of the grain or more serious damage to the grain.

As used herein, “nodal root development” refers to an increase in the number of nodal roots that the cereal grain produces.

As used herein, “nodal root growth” refers to an increase in the length and/or girth of the nodal roots.

As used herein, “effective amount” refers to the amount of the gibberellin that will improve drought stress tolerance or improve yield. The “effective amount” will vary depending on the gibberellin concentration, the cereal(s) being treated, the result desired, and the life stage of the cereal(s), among other factors. Thus, it is not always possible to specify an exact “effective amount.” However, an appropriate “effective amount” in any individual case may be determined by one of ordinary skill in the art.

As used herein, “cereal” or “cereal grain” refers to a cereal that is cultivated for the edible components of its grain. Cereals are members of either the monocot family Poaceae.

As used herein, “early vegetative growth stage” refers to the growth stage that begins at germination and ends when the plant is 50% of the mature plant size.

As used herein, “improving” or “improvement”means that the cereal grain has more of the quality than the cereal grain would have had it if it had not been treated by methods of the present invention.

As used herein, “standability” refers to the resistance to lodging/becoming more than a 45 degree angle from an erect position.

The disclosed embodiments are simply exemplary embodiments of the inventive concepts disclosed herein and should not be considered as limiting, unless the claims expressly state otherwise.

As used herein, all numerical values relating to amounts, weight percentages and the like are defined as “about” or “approximately” each particular value, namely, plus or minus 10% (±10%). For example, the phrase “at least 5% by weight” is to be understood as “at least 4.5% to 5.5% by weight.” Therefore, amounts within 10% of the claimed values are encompassed by the scope of the claims.

The articles “a”, “an” and “the” are intended to include the plural as well as the singular, unless the context clearly indicates otherwise.

The following examples are intended to illustrate the present invention and to teach one of ordinary skill in the art how to use the formulations of the invention. They are not intended to be limiting in any way.

### EXAMPLES

Example 1

Hybrid corn seed was planted 3.8 centimeters (cm) deep on three separate dates in

Miracle-Gro Potting Mix (Miracle-Grois a registered trademark owned by OMS Investments, Inc., Miracle-Gro Potting Mix is widely available at retail home improvement stores) in 2.5 gallon pots. The pots were filled with 0.007 cubic meters of potting mix. The seeds/plants were watered as needed. The second planting was 10 days after the first planting and the third planting was nine days after the second planting.

The plants were treated with 0, 8.4 g ai/hectare, or 16.8 g ai/hectare of GA3 as formulated in RyzUp SmartGrass° (available from Valent BioSciences Corp.) using a TeeJet® 8002 VS spray tip on a manual sprayer set at 15 gallons per acre. Distilled water was used and non-ionic surfactant (0.25% v/v). The treatments were applied on the same day which was 28 days after the first planting (corn was at V6 stage), 18 days after the second planting (corn was at V3 or V4 stages), and 9 days after the third planting (corn was at V1 stage).

Crop Heat Units are a way of calculating growth and are calculated on a daily basis, using the maximum (Tmax) and minimum (Tmin) daily air temperatures, measured from midnight to midnight, in degrees Celsius. The Crop Heat Unit (CHU) system uses the following equation which allows growers to more accurately predict the growth of crops compared to using calendar days: Tmax+Tmin÷2−Tbase, wherein Tbase is the base temperature for the crop.

During this study, there were a few days following the treatments with temperatures exceeding 24 degrees Celsius and the nights dipped below 10 degrees Celsius. The week immediately following treatment, there was one day above 24 degrees Celsius, each night dipped below 10 degrees Celsius. For corn, the Tbase is 10 degrees because corn does not grow below 10 degrees. The growth rate of corn also declines when temperatures are above 30 degrees Celsius. In this study, there was an average of 10 CHUs per day following treatment and a total of 83CHUs.

The corn was harvested at 1, 2, and 3 weeks after treatment. The plants were washed and roots were separated from shoots. The results of this study can be seen below in Table 1.

TABLE 1

| | Untreated | 8.4 g ai/ha | 16.8 g ai/ha |
|---|---|---|---|
| % of plants with | 83 | 83 | 100 |
| newest nodal roots | | | |
| exposed | | | |
| # of newest nodal | 21 | 29 | 33 |
| roots exposed/6 plants | | | |
| # of newest nodal | 4.2 | 5.8 | 5.5 |
| roots exposed/plant | | | |
| with newest nodal | | | |
| roots present | | | |
| # of newest nodal | 3.5 | 4.8 | 5.5 |
| roots exposed/plant | | | |
| cm of newest nodal | 3.2 | 5.0 | 5.3 |
| roots exposed/plant | | | |
| with newest nodal | | | |
| roots | | | |
| cm of newest nodal | 2.7 | 4.2 | 5.3 |
| roots exposed/plant | | | |

As can be seen from the data in Table 1, the treated plants had longer nodal roots (increased nodal growth) and more nodal roots (increased nodal development). This indicates that the treated plants will have better standability and yield.

### Example 2

A greenhouse study was conducted in order to determine the effects of GA3 on root development. Corn seed were planted and grown in the greenhouse. The plants were treated with 0 or 2.75g ai/hectare of GA3 as formulated in RyzUp SmartGrass® using a track sprayer set at 15 gallons per acre. Distilled water was used and non-ionic surfactant (0.25% v/v). The treatments were applied when the corn was at the V4 stage of development. The plants were then destructively harvested and their root count, root dry weight, shoot dry weight, root to shoot ratio, height and V-stage were recorded 7 days or 14 days after the treatment. The results of this study are below in Table 2.

TABLE 2

| Days after | | | | |
|---|---|---|---|---|
| Treatment | Measurement | Control | RUSG | % of Control |
| 7 | Root Count | 8.7 | 8.2 | 94.9 |
| | Root Dry Wt. | 0.3 | 0.5 | 156.1 |
| | Shoot Dry Wt. | 0.9 | 0.9 | 97.4 |
| | Root/Shoot Ratio | 0.4 | 0.6 | 166.0 |
| | Height | 63.9 | 67.4 | 105.5 |
| | V-Stage | 3.5 | 3.2 | 92.1 |
| 14 | Root Count | 12.6 | 12.4 | 98.5 |
| | Root Dry Wt. | 1.6 | 1.7 | 106.5 |
| | Shoot Dry Wt. | 5.5 | 5.9 | 107.8 |
| | Root/Shoot Ratio | 0.4 | 0.4 | 101.2 |
| | Height | 119.2 | 124.6 | 104.5 |
| | V-Stage | 5.4 | 5.5 | 102.4 |

As can be seen from the data in Table 2, the treated plants had increased root dry weights and root to shoot ratios. This indicates that the treated plants will have larger root mass for nutrient and moisture uptake in addition to better standability and yield.

### Example 3

A field study was conducted in order to determine the effects of GA3 on root development. Hybrid corn seeds were planted and were treated when the corn was at the V4 stage of development sixteen days after planting. The treatments were 0 or 2.75g ai/hectare of GA3 as formulated in RyzUp SmartGrass® using a TeeJet® 8002 VS spray tips with a backpack sprayer set at 15 gallons per acre. Distilled water was used and non-ionic surfactant (0.25% v/v). The plants were then destructively harvested and their root count was evaluated. The results of this study are below in Table 3.

TABLE 3

| | Treated Compared to |
|---|---|
| Time of Evaluation | Untreated % of Control |
| 1 day before treatment | 100.2 |
| 4 days after treatment | 105.6 |
| 7 days after treatment | 105.5 |
| 13 days after treatment | 107.8 |

As can be seen from the data in Table 3, the treated plants had an increased number of roots compared to the untreated plants.

### Example 4

Another field study was conducted in order to determine the effects of GA3 on root development. Two types of hybrid corn seeds were planted during the spring season. The plants were treated with 0 or 2.75g ai/hectare of GA3 as formulated in RyzUp SmartGrass® using a TeeJet° 8002 VS spray tip on a manual sprayer set at 15 gallons per acre. Distilled water was used and non-ionic surfactant (0.25% v/v). The treatments were applied when the corn was at the V4 stage of development. The plants were then destructively harvested 32 days after treatments and their number of roots, dry weight, and dry weight of nodal roots were evaluated. The results of this study are below in Table 4.

TABLE 4

| | Treat- | Total | Dry weight of | Dry weight of | Total dry |
|---|---|---|---|---|---|
| Hybrid | ment | roots | nodes 1 to 3 | nodes 4 to 7 | weight |
| 1 | Control | 44.6 | 2.2 | 12.2 | 14.4 |
| 1 | GA3 | 53.2 | 2.5 | 14.4 | 16.9 |
| 2 | Control | 35.8 | 1.9 | 11.3 | 13.2 |
| 2 | GA3 | 39 | 1.7 | 10.1 | 11.8 |

As can be seen from the data in Table 4, the treated plants had an increased number of total roots compared to the untreated plants. Hybrid 1 also showed an increase in the average weight of nodes 1 to 3 and 4 to 7.

### Example 5

Hybrid corn seed was planted and treated with 0.5 oz/acre of RyzUp SmartGrass® at V2 stage of growth, 0.5 oz/acre of RyzUp SmartGrass at V5 stage of growth, or left untreated. Applicants found that the plants treated with RyzUp SmartGrass® had significantly less root lodging damage following severe windstorms. The untreated plants had 3.4% root lodging while the plants treated at V2 and V5 stages had 1.5% and 0.8% lodging, respectively. These numbers reflect actual counts in the fields and not estimates. The root lodged plants were lodged to at least a 45 degree angle from an erect position and were “goosenecked” at harvest. Accordingly, it was determined that gibberellins improve cereal grains' standability.

### Example 6

Corn was treated with 0.5 oz/acre of RyzUp SmartGrass® at V2 stage of growth. Treated and untreated plants were allowed to grow and removed from the soil and examined. The corn plants that were treated with RyzUp SmartGrass had increased root growth and were several inches taller than the untreated plants. The RyzUp SmartGrass® treated plants looked much more robust than the untreated plants.

### Example 7

Corn was treated with 0.5 oz/acre of RyzUp SmartGrass at V5 stage of growth. Treated and untreated plants were allowed to grow and removed from the soil, cut lengthwise, and examined. The RyzUp SmartGrass treated plants looked much more robust than the untreated plants. In addition, the treated corn plants had thicker stalks, significantly larger nodal brace roots, and much longer roots.

### Example 8

Corn was treated with 0.3 or 0.5 oz/acre of RyzUp SmartGrass® at V5 stage of growth. Treated and untreated plants were allowed to grow and removed from the soil and examined. The RyzUp SmartGrass® treated plants looked more robust than the untreated plants. In addition, the treated corn plants had more nodal roots. The treated plants were also taller.

Example 9

Corn was treated with 0.5 oz/acre RyzUp SmartGrass®. Treated and untreated plants were allowed to grow for 12 days and removed from the soil and examined. The RyzUp SmartGrass treated plants looked much more robust than the untreated plants. In addition, the treated corn plants had more nodal roots, were significantly taller (6 inches or more), and had longer and thicker nodal roots.

### Example 10

Corn was treated with 0.3 oz/acre of RyzUp SmartGrass®. Treated and untreated plants were allowed to grow and removed from the soil and examined. The RyzUp SmartGrass® treated plants looked more robust than the untreated plants. In addition, the treated corn plants had more nodal roots. The treated plants were also much taller.

### Example 11

Winter wheat was treated with 0.5 oz/acre of RyzUp SmartGrass in early April plus 110 pounds of nitrogen per acre. The control (untreated) had the same nitrogen application rate. Treated and untreated plants were allowed to grow for about a month and then removed from the soil and examined. The RyzUp SmartGrass® treated plants looked thicker than the untreated plants. In addition, the treated wheat plants had more extensive roots. The treated plants were also taller.

### Example 12

Cereal Rye was treated with 0.5 oz/acre RyzUp SmartGrass®. Treated and untreated plants were allowed to grow and then removed from the soil and examined. The RyzUp SmartGrass® treated plants looked much thicker and healthier than the untreated plants. In addition, the treated cereal rye plants were taller.

1. A method of increasing at least one of nodal root growth, nodal root development, standability and yield of a cereal grain comprising applying an effective amount of at least one gibberellin to the cereal grain during early vegetative growth stage.

2. The method of claim 1 wherein nodal root growth or nodal root development is increased.

3. The method of claim 1 wherein standability is increased.

4. The method of claim 1 wherein yield is increased.

5. The method of claim 1 wherein the cereal grain is exposed to drought stress.

6. The method of claim 1 wherein the cereal grain is selected from the group consisting of corn, rice, wheat, barley, sorghum, millet, oats, triticale, rye, and fonio.

7. The method of claim 1 wherein the cereal grain is selected from the group consisting of corn, rice, rye, wheat, and sorghum.

8. The method of claim 1 wherein the cereal grain is corn.

9. The method of claim 8 wherein the corn is a hybrid corn.

10. The method of claim 1 wherein the gibberellin is selected from the group consisting of gibberellin 1, gibberellin 3 (GA3), gibberellin 4, gibberellin 7, and a combination thereof.

11. The method of claim 10 wherein the gibberellin is GA3 or a combination of gibberellin 4 and 7.

12. The method of claim 10 wherein the gibberellin is GA3.

13. The method of claim 1 wherein the early vegetative growth stage is during the V2 to V6 growth stage.

14. The method of claim 1 wherein the effective amount is from about 1 to 30 grams of gibberellin per hectare.

15. The method of claim 14 wherein the effective amount is from about 3 to 20 grams of gibberellin per hectare.

16. The method of claim 14 wherein the effective amount is from about 6 to 18 grams of gibberellin per hectare.

17. The method of claim 14 wherein the effective amount is from about 8 to 17 grams of gibberellin per hectare.

18. The method of claim 1 wherein the gibberellin is applied with at least one herbicide, fungicide, insecticide, fertilizer or plant growth regulator that is not a gibberellin.

19. The method of claim 18 wherein the gibberellin is applied with a plant growth regulator that is not a gibberellin.

20. The method of claim 18 wherein the plant growth regulator that is not a gibberellin is abscisic acid.
